(19) United States
(12) Patent Application Publication
(10) Pub. No.: US 2024/0221051 A1
(43) Pub. Date: Jul. 4, 2024

(54) CHOICE SIMULATOR

(71) Applicant: Personalized Beauty Discovery, Inc., San Mateo, CA (US)

(72) Inventors: John P. LeFlohic, San Mateo, CA (US); James D. Flick, Copperopolis, CA (US); Gautham Adhithya Thirunavukkarasu, Chengalpet (IN)

(21) Appl. No.: 18/090,698

(22) Filed: Dec. 29, 2022

(51) Int. Cl. G06Q 30/0601; G06Q 30/0201

(52) U.S. Cl. CPC G06Q 30/0631; G06Q 30/0201

(57) ABSTRACT

A dynamic assignment system or distributed resource allocation system and methods performed therein are disclosed. One method is directed towards determining an assignment of a member to a receiver, where choice product success ratios are received, a new member's choice product scores are received, one choice product is identified as a function of choice product success ratios and the member's choice product scores, one member-receiver score is identified, and the new member is identified as ready for assignment. A second method is directed towards determining a chooser limit of choice products required in the dynamic distributional system, where an assignment of the new member identified as a function of one member-receiver score of one new member choice product is received, whether a chooser limit has been reached for a choice product is determined, and the new member is assigned to the one regular receiver or the one neutral receiver.

### BACKGROUND

There are many business models from which a vendor may choose to sell products to customers. One of these business models offer subscription services to subscribers (i.e., customer), where such service could offer a limited number of products in combinations (combos) to their subscribers on a periodic basis, e.g., a monthly basis. A vendor could enter into an arrangement in which each subscriber user receives a monthly shipment of a combo from the products that the vendor has available to sell.

For instance, assume a scenario in which a vendor provides each customer with a combo of five products from fifty stocked or accessible products on a monthly subscription basis. Of the five, the customer may have the option to choose two products from a group of sixteen considered “choices products,” and the vendor would select three products from the remaining thirty-six based upon, for example, known customers' characteristics, preferences, and purchasing history.

Ideally, the vendor would simply send each customer his or her favorite products; unfortunately, there may be many reasons why the vendor cannot. For instance, the quantities of each product that are stocked by the vendor may differ due to a limited number of products that are available to the vendor for purchase. Also, there may be certain products considered “restricted products” that cannot be provided to certain customers. For example, a customer could be allergic to a product(s), and/or one or more states of the United States may ban or place a restriction on a product(s) if it contains particular chemicals or ingredients. If faced with such situation, the vendor will want to avoid assigning such product(s) to the customer.

In some business models, the vendor may have a warehouse in which products are assembled into combos from a limited but unequal number of choice products and regular products; however, the vendor will have to purchase each of the fifty products prior to the beginning of when the combos are assembled. The vendor may not be able to purchase an equal number of choice products and regular products; rather, the number of each may vary resulting in an unlimited count for each product. Once these numbers are known, the vendor could identify which choice products and regular products comprise each combo prior to the beginning the assembling.

In the scenario, customers are considered “choosers” when they choose the choice products they want by making selections from the website. Initially, all sixteen of the choice products are presented on the website. Ideally, the vendor would simply send its customers their favorite five products, including their choice product(s), if they elected to choose one. It is not that simple for many reasons. One reason is that the vendor may have purchased a limited count of each product as discussed above. Moreover, the total count of products that it purchased for a month may be barely enough for all of the customers. This is done to minimize warehouse storage and handling costs. Also, there are restricted products that cannot be shipped to certain choosers.

It is simply not economically feasible for a vendor to customize each combo for each customer for a large number of customers; for over a million customers, this means there could be over a million different combos to assemble, each of which could contain one or more different choice product(s) from the sixteen choice products and one or more different regular product(s) from the thirty-six regular products. Instead, the vendor needs to pick which of the two-hundred fifty combos to assign and send to each customer. Generally, the vendor will try to pick the combo the customer will like most overall, given the products in the combo; however, this becomes complicated since there is scarcity and competition amongst the choosers. More importantly, the vendor must avoid sending customers products which are restricted to some but not others.

Relatively few combos will contain the chooser's choice product. Roughly speaking, of two-hundred fifty combos and sixteen choice products, then only one one-sixteenth of the two-hundred fifty combos, or fifteen combos, will have the chooser's particular choice product in them. For some choosers, their choice may force the vendor to tentatively assign them a combo that, along with their choice product, also contains a restricted product that is a violation for that chooser called a “violation assignment” or “violation.”

In order to avoid violations, the vendor will have to reassign the affected chooser to a “neutral combo” which is a special safety combo created entirely from products that cannot be violations for any customer. In the scenario, there could be thirty-two different variations of neutral combos in which there could be, for example, one, two, or three choice products in each neutral combo, providing the vendor with several combo options for choosers who initially had violations. It is preferable to avoid sending a customer a neutral combo where possible so the vendor can reserved them for customers that end up with violations.

It is a difficult task for a vendor to determine the number or count of each choice product to offer to its customers which also combo assignments that result in violations. As such, constraints and considerations have to be taken into account when assigning a combo to a customer.

### SUMMARY

Embodiments of the inventive concepts disclosed herein are directed to an assignment system which injects computer processing efficiency by providing a “choice simulator” to the assignment problem arising from the above-scenario. This choice simulator produces a chooser limit (or ideal count of choosers) for each choice product with a single run of a comprehensive simulation. The simulation does not begin with initial chooser count estimates; instead, it produces the chooser limit from scratch.

In one aspect, embodiments of the inventive concepts disclosed herein are directed to a method for determining an assignment of a member to a receiver in a dynamic distributional system of a plurality of receivers. The method could include receiving data representative of a plurality of choice product success ratios, receiving data representative of a plurality of a new member's choice product scores, determining one choice product as a function of the plurality of choice product success ratios and the plurality of the member's choice product scores, and identifying one member-receiver score of a plurality of member-receiver scores of the one choice product, where the member is assigned to one regular receiver or one neutral receiver as a result of the identification.

In a further aspect, embodiments of the inventive concepts disclosed herein are directed to a method for determining a count of choice products required in a dynamic distributional system of a plurality of products inclusive of a plurality of choice products and a plurality of regular products. The method could include receiving data representative of an assignment of a new member to one regular receiver of a plurality of regular receivers or one neutral receiver of a plurality of regular receivers, and assigning the new member to one regular receiver of a plurality of regular receivers or one neutral receiver of a plurality of neutral receivers.

In a further aspect, embodiments of the inventive concepts disclosed herein are directed to a dynamic distributional system for performing the methods of the two preceding paragraphs. The system includes a processing unit comprising a new member module, an assignment module, and a choice product success ration module.

### BRIEF DESCRIPTION OF THE DRAWINGS

For a fuller understanding of the inventive embodiments, reference is made to the following description taken in connection with the accompanying drawings in which:

FIG. 1 depicts a functional block diagram of a choice simulator system, in accordance with some embodiments;

FIG. 2 illustrates five products comprising four regular combos and four neutral combos, in accordance with some embodiments;

FIG. 3 illustrates the quantity of the four regular combos and the four neutral combos, in accordance with some embodiments;

FIG. 4A provides a table of choosers, choice products, regular and neutral combos in which the choice products appear, users' combo score for each regular and neutral combo containing the choice products, and regular products restricted from being shipped to the chooser, in accordance with some embodiments;

FIG. 4B provides the table with a reduction of neutral combo scores, in accordance with some embodiments;

FIG. 5 provides a table of assignments of choosers a through k, inclusive, to regular and neutral combos, in accordance with some embodiments;

FIG. 6 provides the table of assignments of choosers a through l, inclusive, to regular and neutral combos, in accordance with some embodiments;

FIG. 7 provides the table of assignments of choosers a through m, inclusive, to regular and neutral combos, in accordance with some embodiments;

FIG. 8 provides the table of assignments of choosers a through n, inclusive, to regular and neutral combos, in accordance with some embodiments;

FIG. 9 provides the table of assignments of choosers a through o, inclusive, to regular and neutral combos, in accordance with some embodiments;

FIG. 10 depicts an exemplary embodiment of a flowchart disclosing a method for determining an assignment of a member to a receiver in a dynamic distributional system of a plurality of receivers, in accordance with some embodiments; and

FIG. 11 depicts an exemplary embodiment of a flowchart disclosing a method for determining a chooser limit required in a dynamic distributional system of a plurality of receivers, in accordance with some embodiments.

### DETAILED DESCRIPTION

In the following description, several specific details are presented to provide a thorough understanding of embodiments of the inventive concepts disclosed herein. One skilled in the relevant art will recognize, however, that the inventive concepts disclosed herein can be practiced without one or more of the specific details or in combination with other components. In other instances, well-known implementations or operations are not shown or described in detail to avoid obscuring aspects of various embodiments of the inventive concepts disclosed herein.

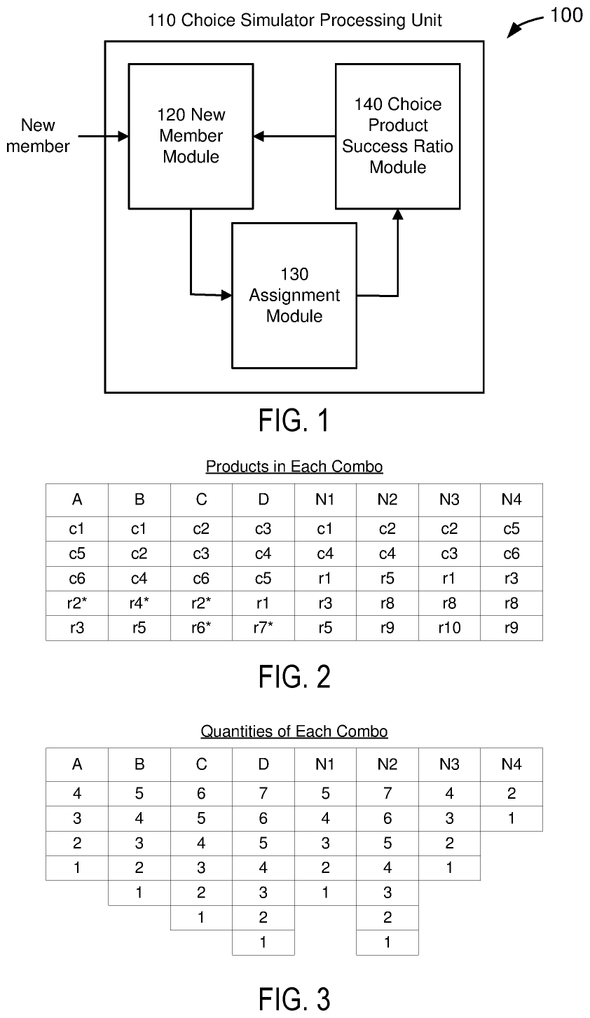

Referring to FIG. 1, an embodiment of a dynamic distributional system 100 suitable for implementation of the inventive concepts described herein. Dynamic distributional system 100 provides a “choice simulator” to the assignment problem. This choice simulator produces chooser limit counts for each choice product with a single run of a comprehensive simulation. The simulation does not begin with initial choice count estimates. Instead, it produces the chooser limits from scratch.

Dynamic distributional system 100 includes choice simulator processing unit (CHSP) 110 with a new member module 120, an assignment module 130, and a choice product success ratio (CPSR) module 140.

CHSP 110 could include any electronic data processing unit which executes software or computer instruction code that could be stored, permanently or temporarily, in a digital memory storage device or a non-transitory computer-readable media (generally, memory) including, but not limited to, cloud storage, random access memory (RAM), read-only memory (ROM), compact disc (CD), hard disk drive, diskette, solid-state memory, secure digital cards, and/or compact flash cards. The CHSP 110 may be driven by the execution of software or computer instruction code containing algorithms developed for the specific functions embodied herein. For the embodiments herein, the term “processor” is not limited to one processing unit and its meaning is not intended to be construed narrowly. For instance, CHSP 110 could also include more than one electronic data processing unit. In some embodiments, CHSP 110 could be a processor(s) used by or in conjunction with any other system(s) which may benefit from the performance of the functions embodied herein

In some embodiments, the terms “programmed” and “configured” are synonymous. CHSP 110 may be electronically coupled to systems and/or sources to facilitate the receipt of input data. In some embodiments, operatively coupled may be considered as interchangeable with electronically coupled. It is not necessary that a direct connection be made; instead, such receipt of input data and the providing of output data could be provided through a bus, through a wireless data/communications network, or as a signal received and/or transmitted by CHSP 110 via a physical or a virtual computer port. CHSP 110 may be programmed or configured to execute the method discussed in detail below. In some embodiments, CHSP 110 may be programmed or configured to receive data from other system(s) which may benefit from the performance of the functions embodied herein. In some embodiments, CHSP 110 may be programmed or configured to provide output data to various systems and/or units which may benefit from the performance of the functions embodied herein.

New member module 120 could be configured to receive a sequential stream of new members—one member at a time—into the dynamic distributional system 100 having a plurality of members and a plurality of receivers, where each receiver is configured to receive a number of members equal to its capacity. It should be noted that the term “member” includes any person, place, or thing that could be assigned, and the term “receiver” could be any person, place, or thing to which the member is assigned.

With each new member, new member module 120 could receive a plurality of choice product success ratios from CPSR module 140 and a plurality of member-receiver scores of choice products of a new member for determining a receiver to which the new member will be assigned as disclosed below. Each choice product success ratio corresponds to one choice product. For each choice product, the member-receiver score corresponding to the receiver may be added to the receiver's current best path cost, and the receiver yielding the greatest sum of the member-receiver score and the receiver's current best path cost is the receiver to which the new member is assigned.

In addition, new member module 120 could receive from assignment module 130 information of a member limit being reached when every regular receiver of the plurality of regular receivers comprising the one new member choice product is full and when every neutral receiver of the plurality of neutral receivers comprising the one new member choice product is full.

Assignment module 130 could be configured to receive new member assignment information from new member module 120, and determine existing member reassignment information as discussed in detail below. As discussed in the preceding paragraph, assignment module 130 could provide new member module 120 with information of a member limit being reached.

CPSR module 140 may be configured to receive reassignment information from assignment module 130, and determine best path and best path cost of one or more members in response as disclosed below. The determination of best cost may be provided to, i.e., made available to, new member module 110 for an assignment of the next new ball

To illustrate the techniques of determining assignments, reassignments, and chooser counts performed by CSPU 110, an exemplary scenario is provided in which customers (choosers or users choosing or selecting products referred to a choice products) may be assigned to regular and neutral combos in a dynamic situation in which the customers are not known prior to joining dynamic distributional system 100.

In the scenario, each combo may include one or more choice products. New members (new choosers), their choice product(s) and corresponding score(s), and their regular product(s) and corresponding score(s) are received sequentially one at a time, where neither the identity of the chooser's choice product(s), corresponding choice product score(s), nor chooser's choice product(s), corresponding choice product score(s) are known until after it has been received.

As discussed herein, the terms “chooser” used herein is synonymous with the term “member” and “ball,” and the tern “combo” used herein is synonymous with the term “receiver” and “cup,” terms that are disclosed by John P. LeFlohic et al. in U.S. patent application Ser. No. 17/716,806, filed on Apr. 8, 2022 and entitled “Methods of Assignment in a Dynamic Distributional System” (collectively, “LeFlohic”), a reference which is hereby incorporated herein in its entirety.

Referring now to FIG. 2, the scenario will include four regular combos A through D, inclusive, and four neutral combos N1 through N4, inclusive. Each combo includes the same number of products, equal to 5. For this scenario, there are five choice products c1 through c5, inclusive, and ten regular products r1 through r10, inclusive. Regular products identified with an asterisk (r2*, r4*, r6*, and r7*) are those which may be restricted to a specific chooser.

Regular combo A includes choice products c1, c5, and c6, and regular products r2* and r3*, where the asterisk as used herein indicates at least one restriction is associated with product; regular combo B includes choice products c1, c2, and c4, and regular products r4* and r5; regular combo C includes choice products c2, c3, and c6, and regular products r2* and r6*; and regular combo D includes c3, c4, and c5; and regular products r1 and r7*. Neutral combo N1 includes choice products c1 and c4, and regular products r1, r3, and r5; neutral combo N2 include choice products c2 and c4, and regular products r5, r8, and r9; neutral combo N3 includes choice products c2 and c3, and regular products r1, r8, and r10; and neutral combo N4 includes choice products c5 and c6, and regular products r3, r8, and r9. As observed, the regular products in the neutral combos are unrestricted; that is, they are not subject to restriction(s).

Referring now to FIG. 3, the chooser counts for each of the four combos are illustrated. As shown, regular combos A, B, C, and D can have a maximum number of 4, 5, 6, and 7 choosers, respectively; similarly, neutral combos N1, N2, N3, and N4 can have a maximum number 5, 7, 4, and 2, respectively, of choosers and non-choosers (the latter being those customers who have not chosen a choice product). For the purpose of the scenario, neither the regular combos nor the neutral combos have been assigned choosers at the beginning of the simulation.

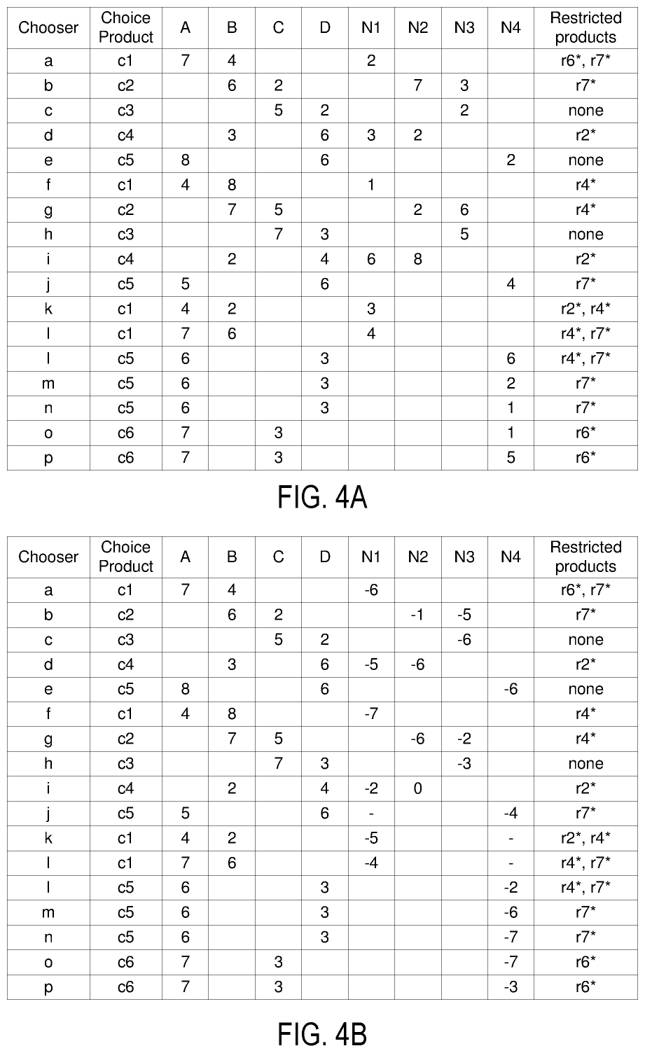

Referring now to FIG. 4A, a table of choosers a through p, inclusive, is presented. With the exception of chooser a to begin the simulation, each row of the table corresponds to one new chooser selected as a function of a “success ratio” established for each choice product as the simulation runs, where the success ratio is defined as a ratio between the number of choosers for the choice product that have been assigned to regular combos and the number of choosers for the choice product that have been assigned to both regular combos and neutral combos having the choice product. The information provided in each row includes the chooser, the chooser's choice product, a numerical score for each regular and neutral combo having the chooser's choice product, and any restricted products applicable to the chooser.

Referring now to FIG. 4B, a table of choosers a through p, inclusive, is presented with scores for the neutral combos A through D reduced to ensure that no neutral combo score is greater than a regular combo score. In some embodiments, the reduction may be determined by a range of possible scores. As shown, the highest score appearing in the table is 8 corresponding to regular combo A of chooser e for and the lowest score is 0 appearing in the table corresponding to neutral combo N3 of chooser b. It should be noted that although the range has been defined as fixed and based upon known assigned scores, the range could be variable and based upon unknown assigned scores prior to the chooser being received for initial assignment; if variable, scores for neutral combos may be revisited and adjusted downward when the range changes.

To begin the scenario, new chooser a has selected choice product c1 which is assumed to have a higher user-choice product score than the other choice products of new chooser a. Choice product c1 is available in regular combos A and B and neutral combo N1 as shown in FIG. 2. As shown in FIG. 4B, regular combos A and B are respectively scored 7 and 4 for chooser a; neutral combo N1 is scored −6 (a ranged-based, downward adjustment from score 2 shown in FIG. 4A); and chooser a is restricted from receiving regular products r6* and r7*, which are not found in regular combos A and B having choice product c1.

In some embodiments, each user-combo score may be determined from user-product scores for both choice and regular products, where a user's preference for each of the products in the combo is scored; a preference for one product over another product is reflected by a higher score. A user-combo score is the sum of the user-product scores for both choice and regular products. For chooser a, the user-combo score of 7 for combo A may be found as the sum of the individual scores of products c1, c5, c6, r2*, and r3 as shown in FIG. 2; the score of 4 for combo B from the sum of individual scores of c1, c2, c4, r4*, and r5; and the score of 2 for combo N1 from the sum of individual scores of c1, c4, r1, r3, and r5.

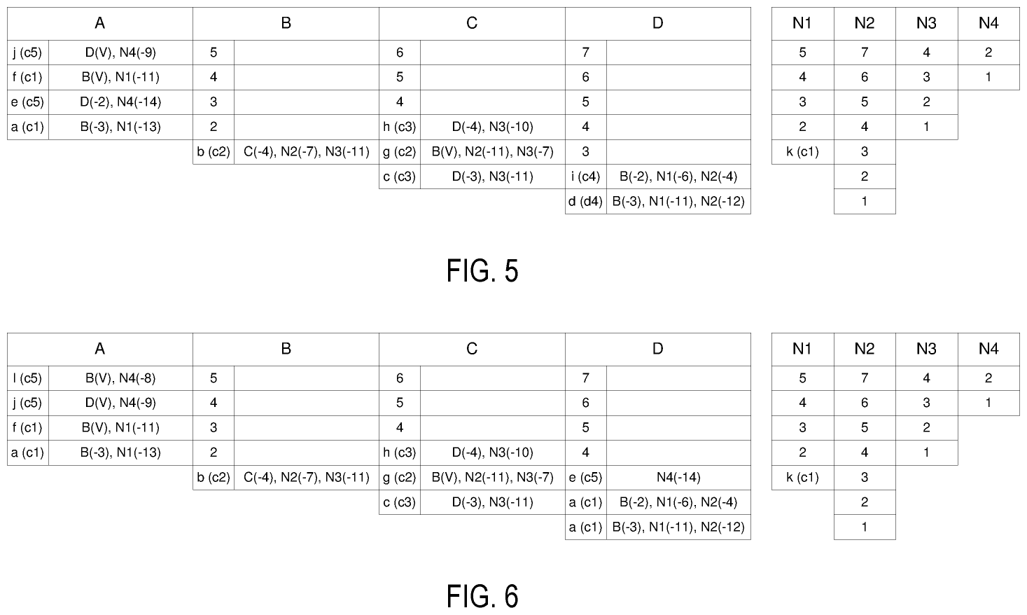

Because chooser a is not restricted from receiving regular products r2* and r4* found in regular combos A and B and because of the chooser's higher user-choice product score, chooser a may be assigned to regular combo A without violation as shown in FIG. 5. Also, regular combo B and neutral combo N1 are respectively assigned score deltas −3 and −13 as shown, indicating each combo's difference with the score 7 (i.e., chooser-combo score of 7) for regular combo A as shown in FIG. 4B. In addition, the success ratio of choice product c1 is 100% because no chooser has been assigned to a neutral combo(s) having choice product c1 (here, neutral combo N1).

It should be noted that, as disclosed by LeFlohic and applied herein, a chooser-combo score corresponds with a ball-cup score, a combo with the highest or greatest score is a preferred combo corresponding to a preferred receiver, a combo with a score other than the highest or greatest is an alternative combo corresponding to an alternative receiver, an assignment of a chooser to his or her preferred combo corresponds to an assignment of the member to a preferred receiver, and an assignment of a chooser to his or her alternative combo corresponds to an assignment of the member to an alternative receiver, and a reassigned chooser to a destination combo corresponds to a reassigned member to a destination receiver.

Continuing, new chooser b has selected choice product c2 which is assumed to have a higher user-choice product score than the other choice products of new chooser b. Choice product c2 is available in regular combos B and C and neutral combos N2 and N3 as shown in FIG. 2. As shown in FIG. 4B, regular combos B and C Are respectively scored 6 and 2 for chooser b; neutral combos N2 and N3 are respectively scored −1 and −5; and chooser b is restricted from receiving regular product r7*, which is not found in regular combos B and C having choice product c2. Because chooser b is not restricted from receiving regular products r2*, r4*, and r6* found in regular combos B and C and because of the chooser's higher user-choice product score, chooser b may be assigned to regular combo B without violation as shown in FIG. 5. Also, a regular combo C, neutral combo N2, and neutral combo N3 are respectively assigned score deltas −4, −7, and −11 as shown. In addition, the success ratio of choice product c2 is 100% because no chooser has been assigned to a neutral combo(s) having choice product c1 (here, neutral combos N2 and N3).

Continuing, new chooser c has selected choice product c3 which is assumed to have a higher user-choice product score than the other choice products of new chooser c. Choice product c3 is available in regular combos C and D and neutral combo N3 as shown in FIG. 2. As shown in FIG. 4B, regular combos C and D are respectively scored 5 and 2 for chooser c; neutral combo N3 is scored −6; and chooser c is not restricted from receiving any of the regular products. Because chooser c is not restricted from receiving regular products r2*, r6*, and r7* found in regular combos C and D and because of the chooser's higher user-choice product score, chooser c may be assigned to regular combo C as shown in FIG. 5. Also, regular combo D and neutral combo N3 are each assigned deltas −3 and −11 without violation as shown. In addition, the success ratio of choice product c3 is 100% because no chooser has been assigned to a neutral combo(s) having choice product c3 (here, neutral combo N3).

Continuing, new chooser d has selected choice product c4 which is assumed to have a higher user-choice product score than the other choice products of new chooser d. Choice product c4 is available in regular combos B and D and combos N1 and N2 as shown in FIG. 2. As shown in FIG. 4B, regular combos B and D are respectively scored 3 and 6 for chooser d; neutral combos N1 and N2 are respectively scored −5 and −6; and chooser d is restricted from receiving regular product r2*, which is not found in regular combos B and D having choice product c4. Because chooser d is not restricted from receiving regular products r4* and r7* found in regular combos B and D and because of the chooser's higher user-choice product score, chooser d may be assigned to regular combo D without violation as shown in FIG. 5. Also, regular combo B and neutral combos N1 and N2 are respectively assigned deltas −3, −11, and −12 as shown. In addition, the success ratio of choice product c4 is 100% because no chooser has been assigned to a neutral combo(s) having choice product c4 (here, neutral combos N1 and N2).

Continuing, new chooser e has selected choice product c5 which is assumed to have a higher user-choice product score than the other choice products of new chooser e. Choice product c5 is available in regular combos A and D and neutral combo N4 as shown in FIG. 2. As shown in FIG. 4B, regular combos A and D are respectively scored 8 and 6 for chooser e; neutral combo N4 is scored −6; and chooser e is not restricted from receiving any of the regular products. Because chooser e is not restricted from receiving regular product r2* found in regular combo A and because of the chooser's higher user-choice product score, chooser e may be assigned to regular combo A without violation as shown in FIG. 5. Also, regular combo D and neutral combo N4 are respectively assigned deltas −2 and −14 as shown. In addition, the success ratio of choice product c5 is 100% because no chooser has been assigned to a neutral combo(s) having choice product c5 (here, neutral combo N4).

It should be observed that each of chooser a through e has been assigned to his or her respective preferred regular combo because each has been assigned to the combo having the highest chooser-combo score.

Continuing, new chooser f has selected choice product c1 which is assumed to have a higher user-choice product score than the other choice products of new chooser f. Choice product c1 is available in regular combos A and B and neutral combo N1 as shown in FIG. 2. As shown in FIG. 4B, regular combos A and B are respectively scored 4 and 8 for chooser f; neutral combo N1 is scored −7; and chooser f is restricted from receiving regular product r4*, which is found in regular combo B having choice product c1. Because chooser f is not restricted from receiving regular product r2* found in regular combo A and because assignment to regular combo B would result in a violation, chooser f may be assigned to regular combo A without violation as shown in FIG. 5. Also, regular combo B cannot be assigned a delta due to the violation (the violation is indicated by “V”), and neutral combo N1 is assigned delta −11 as shown, indicating neutral combo N1 score difference with the score 8 for regular combo A. In addition, the success ratio of choice product c1 remains at 100% because no chooser has been assigned to a neutral combo(s) having choice product c1 (here, neutral combo N1).

Continuing, new chooser g has selected choice product c2 which is assumed to have a higher user-choice product score than the other choice products of new chooser g. Choice product c2 is available in regular combos B and C and neutral combos N2 and N3 as shown in FIG. 2. As shown in FIG. 4B, regular combos B and C are respectively scored 7 and 5 for chooser g; neutral combos N2 and N3 are respectively scored −6 and −2; and chooser g is restricted from receiving regular product r4*, which is found in regular combo B having choice product c2. Because chooser g is not restricted from receiving products r2* and r6* found in combo C and because assignment to regular combo B would result in a violation, chooser g may be assigned to regular combo C without violation as shown in FIG. 5. Also, regular combo B will not be assigned a delta due to the violation, and neutral combos N2 and N3 are respectively assigned deltas −11 and −7 as shown in FIG. 5. In addition, the success ratio of choice product c2 remains at 100% because no chooser has been assigned to a neutral combo(s) having choice product c2 (here, neutral combos N2 and N3).

Continuing, new chooser h has selected choice product c3 which is assumed to have a higher user-choice product score than the other choice products of new chooser h. Choice product c3 is available in regular combos C and D and neutral combo N3 as shown in FIG. 2. As shown in FIG. 4B, regular combos C and D are respectively scored 7 and 3 for chooser h; neutral combo N3 is scored −3; and chooser h is not restricted from receiving any of the regular products. Because chooser h is not restricted from receiving regular products r2* and r6* found in regular combo C and because of the chooser's higher score, chooser h may be assigned to regular combo C without violation as shown in FIG. 5. Also, regular combo D and neutral combo N4 are respectively assigned the deltas −4 and −10 as shown. In addition, the success ratio of choice product c3 remains at 100% because no chooser has been assigned to a neutral combo(s) having choice product c3 (here, neutral combo N3).

Continuing, new chooser i has selected choice product c4 which is assumed to have a higher user-product score than the other choice products of new chooser i. Choice product c4 is available in regular combos B and D and neutral combos N1 and N2 as shown in FIG. 2. As shown in FIG. 4B, regular combos B and D are respectively scored 2 and 4 for chooser i; neutral combos N1 and N2 are respectively scored −2 and 0; and chooser i is restricted from receiving regular product r2*. Because chooser i is not restricted from receiving regular product r7* found in regular combo D and because of the chooser's higher score, chooser i may be assigned to regular combo D without violation as shown in FIG. 5. Also, regular combo B and neutral combos N1 and N2 are respectively assigned the deltas −2, −6, and −4 as shown. In addition, the success ratio of choice product c4 remains at 100% because no chooser has been assigned to a neutral combo(s) having choice product c4 (here, neutral combos N1 and N2).

Continuing, new chooser j has selected choice product c5 which is assumed to have a higher user-choice product score than the other choice products of new chooser j. Choice product c5 is available in regular combos A and D and neutral combo N4 as shown in FIG. 2. As shown in FIG. 4B, regular combos A and D are respectively scored 5 and 6 for chooser j; neutral combo N4 is scored −4; and chooser j is restricted from receiving regular product r7*. Although combo D has a higher score, chooser j is restricted from receiving regular product r7* found in regular combo D. Because chooser j is not restricted from receiving product r2* found in combo A, chooser j may be assigned to regular combo A without violation as shown in FIG. 5. Also, regular combo D will not be assigned a delta due to the violation, and neutral combo N4 is assigned delta −9 as shown. In addition, the success ratio of choice product c5 remains at 100% because no chooser has been assigned to a neutral combo(s) having choice product c5 (here, neutral combs N4).

It should be observed that choosers f, g, and j have been assigned to alternative regular combos, and choosers h and i have been assigned to preferred regular combos. Also, as disclosed by LeFlohic and applied herein, the best cost delta for each of combos A through D, inclusive, are −2, −4, −3, and −2, respectively; the best path for each of combos A through D, inclusive, are to combos D, C, D, and B, respectively.

As shown in FIG. 5, the number of choosers assigned to regular combo A has reached the maximum available quantity of regular combo A; that is, it is a fully-assigned combo with users that are currently assigned. As such, regular combo A cannot accept assignments of new choosers unless a chooser currently assigned to regular combo A is reassigned as discussed in detail below.

Continuing, new chooser k has selected choice product c1 which is assumed to have a higher user-choice product score than the other choice products of new chooser k. Choice product c1 is available in regular combos A and B and neutral combo N1 as shown in FIG. 2. As shown in FIG. 4B, regular combos A and B are respectively scored 4 and 2 for chooser k; neutral combo N1 is scored −5; and chooser k is restricted from receiving regular products r2* and r4*, which are found in regular combo A and B having choice product c1. Because chooser k is restricted from receiving regular products r2* and r4* respectively found in regular combos A and B, chooser k may not be assigned to either of regular combos A or B without violation as shown in FIG. 5. Since neutral combos do not have any regular product subject to a restriction that can result in a violation, chooser k may be assigned to neutral combo N1 as shown. When a chooser can be assigned multiple neutral combos, the chooser may be assigned to the neutral combo resulting in the lowest cost.

The assignment of chooser k to a neutral assignment may be considered as a “fail” because a chooser has been assigned to a neutral combo, thereby reducing the success ratio of the choice product. Specifically, the success ratio has dropped from 100% because the ratio of the number of choosers of choice product c1 in regular combos (here, combo A) is equal to 2 and the number of choosers of choice product c1 in regular combos (here, combo A) and neutral combos (here, combo N1) is equal to 3, thereby resulting in a success ratio of choice product c1 is 66.67%, the quotient of the 2/3=0.67.

Continuing, it is assumed that choice product c1 for chooser l has the highest user-choice product score than the other choice products of new chooser l; however, the success ratio of choice product c1 is relatively low. As such, choice product c1 is not available for selection by new chooser l due to the relative low success ratio; in other words, choice product c1 has been disabled from being chosen. As such, the next highest-choice product that is not disabled may be selected.

New chooser l has selected choice product c5 which is assumed to be the highest user-choice product now that choice product c1 has been disabled. As shown in FIG. 4B, regular combos A and D are respectively scored 6 and 3 for new chooser l; neutral combo N1 is scored −2; and chooser l is restricted from receiving regular products r4* and r7* found in regular combos B and D. Since new chooser l is not restricted from receiving products r2* found in combo A, new chooser l may be assigned to regular combo A without violation if one of the existing choosers currently assigned to regular combo A can be reassigned.

As shown in FIG. 5, existing choosers a and e may be reassigned to regular combos B and D; existing choosers f and j may only be reassigned to neutral combos N1 and N4, respectively, due to the violations. Existing chooser a has chosen choice product c1 which is available in regular combo B but not regular combo D. As shown in FIG. 5, the best cost delta is −2 for existing chooser e corresponding to regular combo D (defining the best path for combo A). As such, existing chooser e may be reassigned to regular combo D having existing chooser e's choice product c5 as shown in FIG. 6. This reassignment of existing chooser e enables new chooser l to be assigned to regular combo A having choice product c1 as shown.

The assignment of new chooser l to regular combo A has increased the success ratio of choice product c1 to 75.00%, for the number choosers of choice product c1 in regular combo(s) (here, regular combo A) equals 3 and the number choosers of choice product c1 in regular and neutral combos A and N1 equals 4. Moreover, the success ratio of choice product c5 of reassigned chooser e remains 100% because chooser e has not been assigned to a neutral combo. As a result, the assignment and reassignment may be considered a “success” for both choice products c1 and c5.

Continuing, new chooser m has selected choice product c5 which is assumed to have a higher user-choice product score than the other choice products of new chooser m. Choice product c5 is available in regular combos A and D and neutral combo N4 as shown in FIG. 2. As shown in FIG. 4B, regular combos A and D are respectively scored 6 and 3 for chooser m; neutral combo N4 is scored −6; and new chooser m is restricted from receiving regular product r7* found in combo D. Because new chooser m is not restricted from receiving regular product r2* found in regular combo A, new chooser m may be assigned to regular combo A without violation if one of the existing choosers currently assigned to regular combo A can be reassigned.

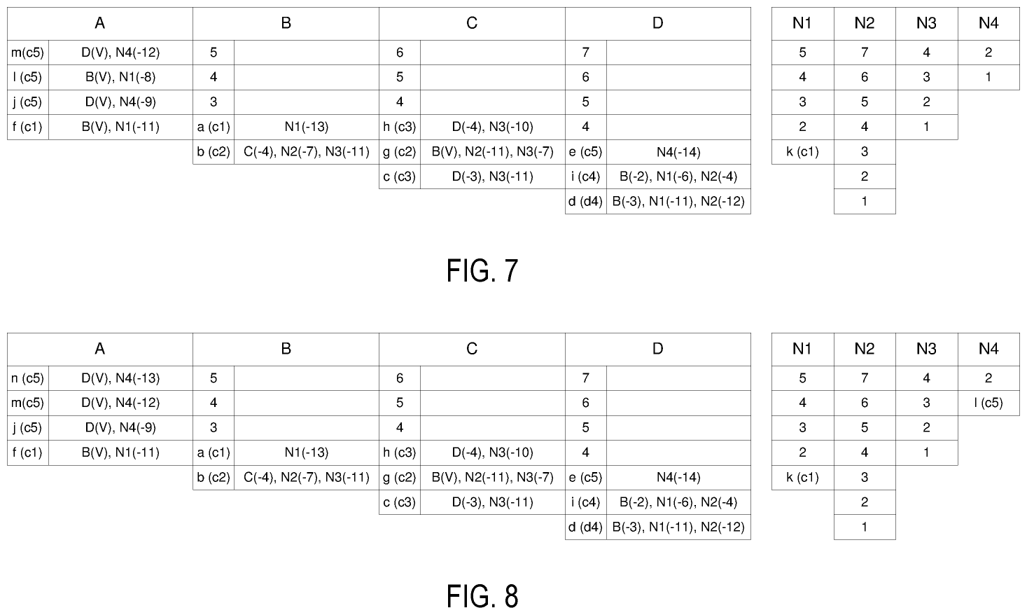

As shown in FIG. 6, existing chooser a is the only chooser that may be reassigned to a regular combo (regular combo B); existing choosers f, j, and l may only be reassigned to neutral combos N1 and N4. As such, existing chooser a may be reassigned to regular combo B having choice product c1 as shown in FIG. 7.

This reassignment of existing chooser a enables new chooser m to be assigned to regular combo A having choice product c5 as shown. The reassignment of existing chooser a to regular combo B has not affected the success ratio of choice product c1 of 75.00%, for the number of times choosers of choice product c1 in regular combos (here, regular combos A and B) equals 3, and the number of times choosers of choice product c1 in regular and neutral combos A and N1 equals 4. Moreover, the success ratio of choice product c5 remains 100% because no chooser of choice product c5 has not been assigned or reassigned to a neutral combo. As a result, the respective assignment and reassignment of choosers m and a may be considered a “success” for choice products c1 and c5.

Continuing, new chooser n has selected choice product c5 which is assumed to have a higher user-choice product score than the other choice products of new chooser n. Choice product c5 is available in regular combos A and D and neutral combo N4 as shown in FIG. 2. As shown in FIG. 4B, regular combos A and D are respectively scored 6 and 3 for new chooser n; neutral combo N4 is scored −7; and new chooser n is restricted from receiving regular product r7* found in combo D. Because new chooser n is not restricted from receiving regular product r2* found in regular combo A, new chooser n may be assigned to regular combo A without violation if one of the existing choosers assigned to regular combo A can be reassigned.

As shown in FIG. 7, none of the existing choosers in regular combo A may be assigned to another regular combo; instead, existing chooser f may be reassigned to neutral combo N1, and existing choosers j, l, and m may be reassigned to neutral combo N4. As shown, existing chooser l has the best cost delta (−8) for regular combo A if reassigned to neutral combo N4. Because neutral combo N4 is not fully-assigned, existing chooser l may be reassigned to neutral combo N4 as shown in FIG. 8.

This reassignment of existing chooser l enables new chooser n to be assigned to regular combo A having choice product c5 as shown. The reassignment of existing chooser l to neutral combo N1 has decreased the success ratio of choice product c5 to 80.00%, for the number of times choosers of choice product c5 in regular combos (i.e., regular combos A and D) equals 4 and the number of times choosers of choice product c5 in regular and neutral combos A, B, and N1 equals 5. As a result, the reassignment of existing chooser l may be considered a “fail” for choice product c5.

Continuing, it is assumed that choice products c1 and c5 for new chooser o have higher user-choice product scores than the other choice products; however, the success ratios of choice product c1 and c5 are relatively low. As such, choice products c1 and c5 are not available for selection by new chooser o because they have been disabled from being selected due to the relative low success ratios. As such, another choice product having the highest-choice product that is not disabled may be selected.

New chooser o has selected choice product c6 which is assumed to be the highest user-choice product now that choice products c1 and c5 have been disabled. Choice product c6 is available in regular combos A and C and neutral combo N4 as shown in FIG. 2. As shown in FIG. 4B, regular combos A and C are respectively scored 7 and 3 for new chooser o; neutral combo N4 is scored −7; and new chooser o is restricted from receiving regular product r6* found in combo C. Because new chooser o is not restricted from receiving regular product r2* found in regular combo A, new chooser o may be assigned to regular combo A without violation if one of the existing choosers assigned to regular combo A can be reassigned.

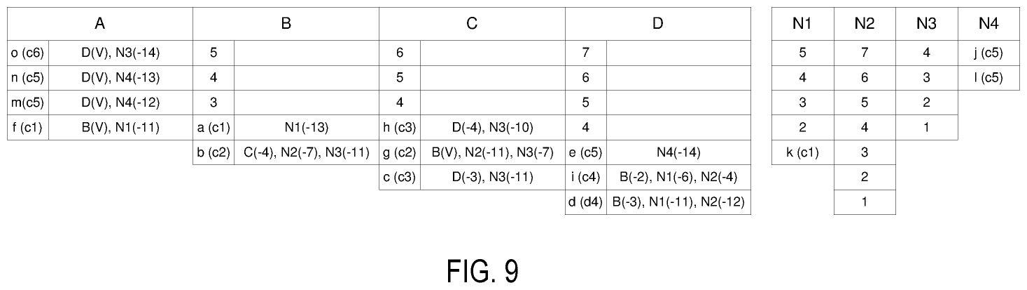

As shown in FIG. 8, none of the existing choosers in regular combo A may be assigned to another regular combo; instead, existing chooser f may be reassigned to neutral combo N1, and existing choosers j, m, and n may be reassigned to neutral combo N4. As shown, existing chooser j has the best cost delta (−9) for regular combo A if reassigned to neutral combo N4. Because neutral combo N4 is not fully-assigned, existing chooser j may be reassigned to neutral combo N4 as shown in FIG. 9.

This reassignment of existing chooser j enables new chooser o to be assigned to regular combo A having choice product c6 as shown. The reassignment of existing chooser j to neutral combo N4 has decreased the success ratio of choice product c5 to 60.00%, for the number of times choosers of choice product c5 in regular combos (i.e., regular combos A and D) equals 3 and the number of times choosers of choice product c5 in regular and neutral combos A, D, and N4 equals 5. As a result, the respective assignment and reassignment of choosers o and j may be considered a “fail” for choice product c5.

Continuing, it is assumed that choice products c1 and c5 for new chooser p have higher user-choice product scores than the other choice products; however, the success ratios of choice product c1 and c5 are relatively low. As such, choice products c1 and c5 are not available for selection by new chooser p because they have been disabled from being selected due to the relative low success ratios. As such, another choice product having the highest-choice product that is not disabled may be selected.

New chooser p has selected choice product c6 which is assumed to be the highest user-choice product now that choice products c1 and c5 have been disabled. Choice product c6 is available in regular combos A and C and neutral combo N4 as shown in FIG. 2. As shown in FIG. 4B, regular combos A and C are respectively scored 7 and 3 for new chooser p; neutral combo N4 is scored −3; and new chooser p is restricted from receiving regular product r6* found in combo C. Because new chooser p is not restricted from receiving regular product r2* found in regular combo A, new chooser p may be assigned to regular combo A without violation if one of the existing choosers assigned to regular combo A can be reassigned.

As shown in FIG. 9, none of the existing choosers in regular combo A may be assigned to another regular combo; instead, existing chooser f may be reassigned to neutral combo N1, and existing choosers m, n, and o may be reassigned to neutral combo N4. As shown in regular combo A, existing chooser f has the best cost delta (−11) if reassigned to neutral combo N1; however, new chooser p has a better best cost delta (−3) if assigned to N4.

As shown, neutral combo N4 is full with existing choosers who were reassigned as discussed above. As such, neutral combo N4 cannot accept the assignment of new chooser p unless an existing chooser currently assigned to neutral combo N4 is reassigned to another neutral combo with the existing chooser's choice product; however, for choice product c5, there is no other neutral combo besides neutral combo N4 as shown in FIG. 2.

Because there is no other open regular or neutral combo to which a chooser with choice product c5 that is not full, chooser p becomes an unassignable chooser, for the chooser's choice product c5 has been assigned to as many regular and neutral combos having choice product c5. As such, choice product c5 reached its chooser limit. Because chooser p has become unassignable, the chooser limit for choice product c5 may be determined by summing the number of existing choosers of choice product c5 assigned among all of the regular and neutral combos. Referring to FIG. 9, two existing choosers (i.e., choosers m and n) of choice product c5 appear in regular combo A, one existing chooser (i.e., chooser e) in regular combo D, and two existing choosers (i.e., choosers l and j) in neutral combo N4; accordingly, the chooser limit (i.e. the ideal choice count of choosers) of choice product c5 is 5. The steps of the preceding discussion may be continued until the chooser limits for all of the choice products are determined when a chooser for each choice product become unassignable.

It should be noted that the preceding scenario is simplified for the purpose of illustration. In actual practice, the numbers presented above would be considered statistically insignificant when applied to a vendor who has hundreds of combos to offer to millions of subscribers.

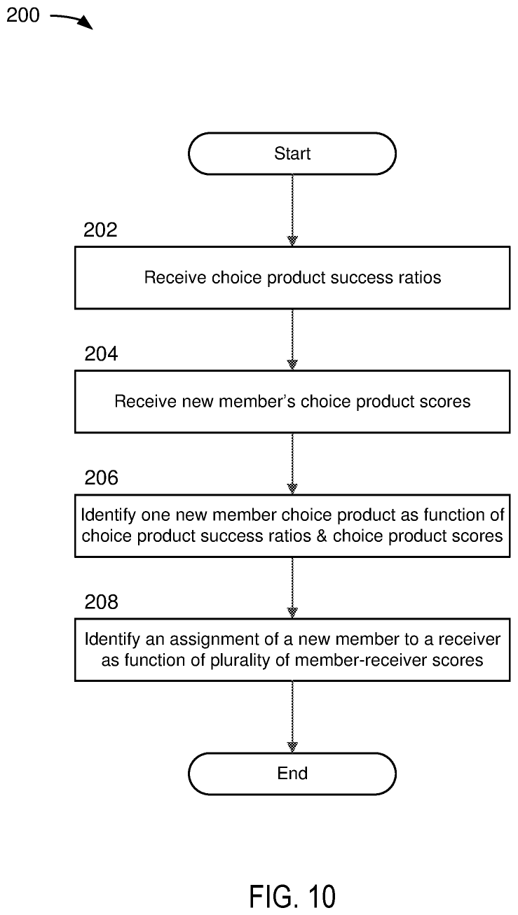

Referring now to FIG. 10, flowchart 200 is depicted disclosing an exemplary method for determining an assignment of a new member (e.g., chooser) in a sequence of new members to a receiver (e.g., combo) in a dynamic distributional system of a plurality of receivers that includes one regular receiver (e.g., one regular combo) or one neutral receiver (e.g., one neutral combo) in dynamic distributional system 100.

The method of flowchart 200 begins with module 202 with the system receiving data representative of a plurality of choice product success ratios, where each success ratio corresponds to one choice product. In some embodiments, each choice product success ratio may be determined as a function of a quantity of a plurality of existing choosers of the choice product are assigned to regular receivers and a quantity of a plurality of existing choosers of the choice product are assigned to neutral receivers to which the choice product is assigned as discussed in module 304 of flowchart 300 below.

The method of flowchart 200 continues with module 204 with the system receiving data representative of a plurality of a new member's choice product scores; that is, the system receiving data representative of a product score for each choice product of a plurality of choice products corresponding to the new member. In some embodiments, each choice product is numerically scored for the new member, where each choice product score is different form the others and sortable from highest to lowest.

The method of flowchart 200 continues with module 206 with the system identifying one new member choice product as a function of the plurality of choice product success ratios and the plurality of the new member's choice product scores. In some embodiments, a relatively low choice product success ratio disables the choice product corresponding to the ratio; as such, the choice product is not available for or not included in the identification, even if it corresponds to the highest choice product score of the new member. In some embodiments, the identification is based upon the highest choice product score of a choice product of the new member having a relatively high choice product success ratio which isn't disabled.

The method of flowchart 200 continues with module 208 with the system identifying an assignment of the new member to a receiver as a function of a plurality of member-receiver scores. In some embodiments, each member-receiver score corresponds to one receiver of a plurality of receivers having the one choice product identified in module 206. In some embodiments, each member-receiver score is determined as the sum of the choice product score and the scores of the other products of the corresponding receiver. In some embodiments, the assignment identification may be to assignment module 130 for assignment of the new member to the assigned receiver. Then, the method of flowchart 200 ends.

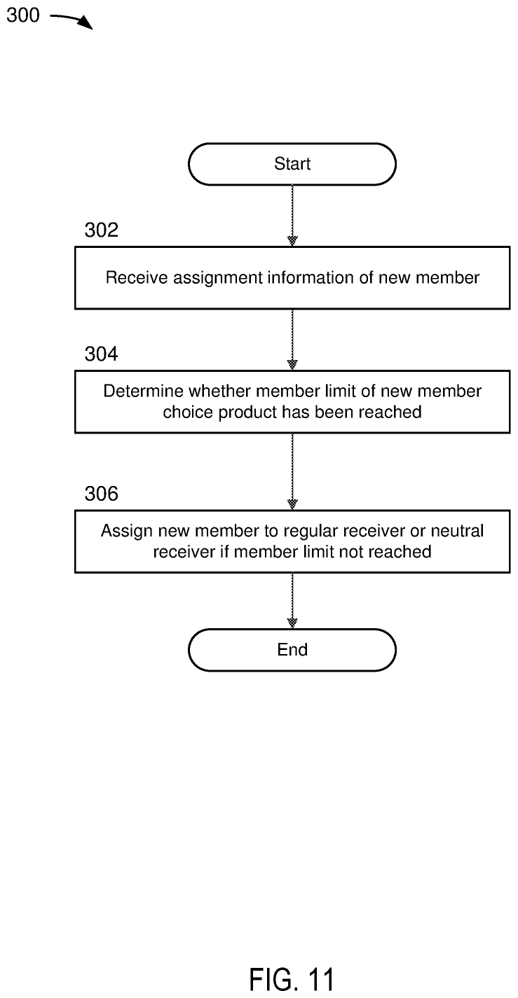

Referring now to FIG. 11, flowchart 300 is depicted disclosing an exemplary method for determining member limits (e.g., chooser limits) required in a dynamic distributional system of a plurality of products comprising of a plurality of receivers, a plurality of choice products, and/or a plurality of regular products

The method of flowchart 300 begins with module 302 with the system receiving data representative of an identification of a new member for an assignment to one regular receiver of a plurality of regular receivers or one neutral receiver of a plurality of regular receivers as disclosed in flowchart 200.

The method of flowchart 300 begins with module 304 with the system determining whether a member limit of the new member choice product has been reached. As discussed above, the member limit of the new member choice product may be considered as being reached when the all of the regular receivers having the one new member choice product is full and when all of the neutral receivers having the one new member choice product is full.

The method of flowchart 300 continues with module 306 with the system assigning, when the member limit of the new member choice product has not been reached, the new member to an assigned to one receiver that could be one regular receiver of a plurality of regular receivers or one neutral receiver of a plurality of neutral receivers. In some embodiments, the system may reassign an existing member in the assigned receiver to a destination receiver if the assigned receiver is determined to be a full receiver.

In some embodiments, an assignment of the new member to a regular receiver increases the choice product success ratio, and an assignment of the new member to a neutral receiver decreases the choice product success ratio. In some embodiments, an assignment of the new member to a regular receiver increases a choice product success ratio if it is less than 100%, and an assignment of the new member to a neutral receiver decreases the choice product success ratio. In some embodiments, information corresponding to the increase or decrease of the choice product success ratio for the choice product is provided to new member module 120 for determining a chooser limit of the choice product. Then, the method of flowchart 300 ends.

It should be noted that the steps of the method described above may be embodied in computer-readable media stored in a non-transitory computer-readable medium as computer instruction code. The method may include one or more of the steps described herein, which one or more steps may be carried out in any desired order including being carried out simultaneously with one another. For example, two or more of the steps disclosed herein may be combined in a single step and/or one or more of the steps may be carried out as two or more sub-steps. Further, steps not expressly disclosed or inherently present herein may be interspersed with or added to the steps described herein, or may be substituted for one or more of the steps described herein as will be appreciated by a person of ordinary skill in the art having the benefit of the instant disclosure.

As used herein, the term “embodiment” means an embodiment that serves to illustrate by way of example but not limitation.

It will be appreciated to those skilled in the art that the preceding examples and embodiments are exemplary and not limiting to the broad scope of the inventive concepts disclosed herein. It is intended that all modifications, permutations, enhancements, equivalents, and improvements thereto that are apparent to those skilled in the art upon a reading of the specification and a study of the drawings are included within the broad scope of the inventive concepts disclosed herein. It is therefore intended that the following appended claims include all such modifications, permutations, enhancements, equivalents, and improvements falling within the broad scope of the inventive concepts disclosed herein.

What is claimed is:

1. A method for determining an assignment of a new member in a dynamic distributional system, comprising:
receiving, by a processing unit including at least one processor coupled to a non-transitory processor-readable medium storing processor-executable code, data representative of a plurality of choice product success ratios;
receiving data representative of a plurality of new member choice product scores;
identifying one new member choice product as a function of the plurality of choice product success ratios and the plurality of new member choice product scores; and
identifying one new member-receiver score of a plurality of new member-receiver scores of the one new member choice product, whereupon
data representative of an identification of one new member is provided to an assignment module of the processing unit in response to the identification of the one new member-receiver score for an assignment of the one new member to one regular receiver of a plurality of regular receivers or one neutral receiver of a plurality of neutral receivers.

2. The method of claim 1, wherein each choice product success ratio of the plurality of choice product success ratios corresponds to one choice product of a plurality of choice products.

3. The method of claim 1, wherein each choice product success ratio of the plurality of choice product success ratios is determined as a function of a first quantity of existing members of the choice product assigned to a plurality of regular receivers and a second quantity of existing members of the choice product assigned to a plurality of neutral receivers.

4. The method of claim 3, wherein the function for determining each choice product success ratio of the plurality of choice product success ratios is a quotient between the first quantity and a sum of the first quantity and the second quantity.

5. The method of claim 1, wherein the function for identifying the one new member choice product does not include at least one new member because of the at least one new member's choice product success ratio.

6. The method of claim 1, wherein each new member-receiver score of the plurality of new member-receiver scores is determined from product scores of the new member corresponding choice and neutral products of one receiver of the plurality of regular receivers and the plurality of neutral receivers.

7. The method of claim 1, wherein each new member-receiver score of the plurality of new member-receiver scores corresponds to one regular receiver of the plurality of regular receivers or one neutral receiver of the plurality of neutral receivers.

8. The method of claim 1, wherein the identification of the one new member for assignment corresponds to the highest new member-receiver score of the plurality of new member-receiver scores.

9. A method for determining a member limit in a dynamic distributional system of a plurality of receivers, comprising:
receiving, by a processing unit including at least one processor coupled to a non-transitory processor-readable medium storing processor-executable code, data representative of an identification of a new member for an assignment to one regular receiver of a plurality of regular receivers or one neutral receiver of a plurality of regular receivers, where
the identification of the new member is determined as a function of one member-receiver score of a plurality of member-receiver scores of one new member choice product of the new member;
determining whether a member limit of the new member choice product is reached; and
assigning, when the member limit of the new member choice product is not reached, the new member to the one regular receiver of the plurality of regular receivers or the one neutral receiver of a plurality of regular receivers, where
an assignment of the new member to the one regular receiver increases a choice product success ratio of one new member choice product, and
an assignment of the new member to the one neutral receiver decreases the choice product success ratio of the one new member choice product, whereupon
information corresponding to the increase or decrease is provided to a new member module of the processing unit for determining an assignment of a next new member.

10. The method of claim 9, wherein the member limit of the new member choice product is reached when every regular receiver of the plurality of regular receivers comprising the one new member choice product is full and when every neutral receiver of the plurality of neutral receivers comprising the one new member choice product is full.

11. The method of claim 10, wherein information corresponding to the new member choice product reaching its member limit is provided to a new member module of the processing unit.

12. The method of claim 9, further comprising:
reassigning an existing member in the regular receiver assigned to the new member, where
the reassignment of the existing member to a second regular receiver of the plurality of regular receivers does not increase or decrease a choice product success ratio of an existing member choice product.

13. The method of claim 9, further comprising:
reassigning an existing member in the regular receiver assigned to the new member, where
the reassignment of the existing member to a neutral receiver of the plurality of neutral receivers decreases a choice product success ratio of an existing member choice product, whereupon
information corresponding to the decrease is provided to a new member module of the processing unit for determining an assignment of a next new member.

14. The method of claim 9, further comprising:
reassigning an existing member in the neutral receiver assigned to the new member, where
the reassignment of the existing member to a second neutral receiver of the plurality of neutral receivers does not increase or decrease a choice product success ratio of an existing member choice product.

15. A dynamic distributional system of a plurality of products, comprising:
a processing unit at least one processor coupled to a non-transitory processor-readable medium storing processor-executable code and having a new member module, an assignment module, and a choice product success ratio module, where
the new member module is configured to:
receive data representative of a plurality of choice product success ratios,
receive data representative of a plurality of new member choice product scores, where
each choice product success ratio of the plurality of choice product success ratios corresponds to one choice product of a plurality of choice products
identify one new member choice product as a function of the plurality of choice product success ratios and the plurality of new member choice product scores,
identify one new member-receiver score of a plurality of new member-receiver scores of the one new member choice product, and
provide data representative of an identification of one new member to the assignment module in response to the identification of the one new member-receiver score;
the assignment module is configured to:
receive the data representative of the identification of one new member,
determine whether a member limit of the new member choice product is reached, and
assign, when the member limit of the new member choice product is not reached, the new member to the one regular receiver of the plurality of regular receivers or the one neutral receiver of a plurality of regular receivers, and
provide data representative of the assignment of the new member to the choice product success ratio module; and
the choice product success ratio module is configured to:
receive the data representative of the assignment of the new member,
determine whether a member limit of the new member choice product is reached;
assign, when the member limit of the new member choice product is not reached, the new member to the one regular receiver of the plurality of regular receivers or the one neutral receiver of a plurality of regular receivers, where
an assignment of the new member to the one regular receiver increases a choice product success ratio of one new member choice product, and
an assignment of the new member to the one neutral receiver decreases the choice product success ratio of the new member choice product, and
provide data representative of the information corresponding to the increase or decrease of the choice product success ratio of the new member choice product to the new member module.

16. The system of claim 15, wherein each choice product success ratio of the plurality of choice product success ratios corresponds to one choice product of a plurality of choice products.

17. The system of claim 15, wherein each choice product success ratio of the plurality of choice product success ratios is determined as a function of a first quantity of existing members of the choice product assigned to a plurality of regular receivers and a second quantity of existing members of the choice product assigned to a plurality of neutral receivers.

18. The system of claim 15, wherein each new member-receiver score of the plurality of new member-receiver scores is determined from product scores of the new member corresponding choice and neutral products of one receiver of the plurality of regular receivers and the plurality of neutral receivers.

19. The system of claim 15, wherein the member limit of the new member choice product is reached when every regular receiver of the plurality of regular receivers comprising the one new member choice product is full and when every neutral receiver of the plurality of neutral receivers comprising the one new member choice product is full.

20. The system of claim 19, wherein information corresponding to the new member choice product reaching its member limit is provided to the new member module.
